(19) United States
(12) Patent Application Publication
(10) Pub. No.: US 2009/0166283 A1
(43) Pub. Date: Jul. 2, 2009

(54) Filter Device and Method for Purifying Polluted Liquids

(76) Inventor: Torsten Hackner, Ingoldstadt (DE)

Correspondence Address: DORITY & MANNING, P.A., POST OFFICE BOX 1449, GREENVILLE, SC, 29602-1449, US

(21) Appl. No.: 11/720,644

(22) PCT Filed: Nov. 16, 2005
(86) PCT No.: PCT/EP05/55999

§ 371 Date: Jun. 1, 2007

(30) Foreign Application Priority Data
Dec. 3, 2004 (DE) 10 2004 063 879.9

(51) Int. Cl. B01D 33/21; B01D 33/68

(52) U.S. Cl. 210/391

(57) ABSTRACT

The invention relates to a filter device (1) for purifying polluted liquids, especially waster water, said device consisting of a plurality of interspaced filter elements (4) which form filter modules (3) and are rotatably arranged, in a circular or polygonal manner, in a container (2) containing the untreated liquid. Said filter modules (3) arranged in a circular or polygonal manner form a cavity (14) which is connected to the container (2) by means of a suction opening (12). A cleaning device for cleaning the filter elements (4) by means of purging air is arranged on and/or in the cavity (14). The invention also relates to a method for cleaning filter elements (4) pertaining to a filter device (1). According to said method, rotating filter elements (4) are cleaned by means of purging air during the operation of the filter device. To this end, the filter elements (4) are rotatably arranged in an interspaced and circular or polygonal manner, forming a cavity (14), in a container (2) containing the untreated liquid.

This invention refers to a filter device for the purification of polluted liquids, especially waste water, during cleaning and treatment. The filter device consists of several interspaced filter elements that make up the filter modules and are rotatably arranged, in a circular or polygonal manner, in a container that contains the filter liquid. The filter modules arranged in a circular or polygonal manner form a cavity, which is connected to the container by means of a suction opening.

The filter elements of such filter devices consist of trapeze-shaped filter plates equipped on both sides with filters that have a special structure for letting off the filtrate. At the start of the rotating movement of the filter modules in the liquid that is still standing still, a flow resistance appears on the filter surfaces, which initially prevents the solids that were kept back from depositing on the filter surfaces. As the filter device continues rotating, however, the relative speed of the liquid towards the plates decreases because the liquid being filtered is increasingly circulated. Therefore, as the filtering progresses, coating layers made up of solids form on the filters, thereby decreasing the degree of effectiveness of the filter device.

To eliminate the coating layers that impede filtration, it is known from DE 195 37 578, for example, that filters can be equipped with a reversible flow device. In order to do this, purified liquid coming from the draining side is pressed through the filter plates in order to take away the solid layers sticking to them. If cleaning is incomplete, the reversible flow can be further strengthened with a connected suction pump. However, in this cleaning process, the reversible flow device causes mechanical wear on the filters, thus reducing their useful life. In some types of filters, such a reversible flow device can lead to filter destruction, so that reversible flow cannot be used with all filters. The liquid used for cleaning the filters flows back to the container after the solids have accumulated in it and is subject to the filtering process once again, which leads to a considerable reduction of filtering power. In addition, between the cleaning stages of the filtering process, the discontinuous cleaning causes the constant formation of new coating layers made up of the solids that were kept back, which have a negative impact on the degree of effectiveness of the filtering process.

A cleaning device is known from WO 01/80971 A1 that achieves a continuous and wear-proof filter cleaning that prevents the formation of coating layers during the filtering process. The filter modules arranged in a circular or polygonal manner form a cavity closed on one side and connected to the container on the other side by means of a suction opening. The cavity is made to work effectively with a flow element such as a pump bucket wheel. By this means, a constant flow resistance is generated by the swirling of the untreated liquid between the neighboring filter elements, thereby cleaning the filters and largely preventing solids from depositing. The untreated liquid in the container is used for the cleaning process, so the effectiveness of the filters in the device is not adversely affected. However, the disadvantage of this is the high energy consumption of the flow element and the corresponding costs, so that such a filter device can be profitably operated only under a high flow. Additionally, the cleaning is done with polluted water, which in the case of some applications—in other words, when the liquid is highly polluted—does not lead to an optimal result.

Therefore, the task of the invention is to prevent the disadvantages of current technology and to create a rotating filter device to purify liquids that can also be used efficiently with small and medium flows.

The problem is solved with a filter device for purifying polluted liquids and a process for cleaning the filter elements of a filter device that has the features of the independent claims.

A filter device according to the invention for the purification of polluted liquids consists of several interspaced filter elements that form filter modules and are rotatably arranged in a container in a circulatory or polygonal manner. In this case, the filter modules form a cavity connected to the container that contains the untreated liquid via a suction opening. In or on the cavity, a cleaning device for cleaning the filter elements with purging air has been arranged. Owing to the centric arrangement of the cleaning device in the cavity, in conjunction with the rotating filter elements, the cleaning of the filter elements can be especially effective and even be carried out economically even under low flow conditions.

A considerable advantage of this arrangement is the inclusion of a lance as cleaning device for directing the purging air into the cavity. The purging air can be directed specifically to the areas to be cleaned, thereby making a very effective cleaning possible.

An advantageous design of the invention foresees the lance to have many openings for the purging air that correspond to the number of the interspaced filter elements. This feature allows the flow of air to specifically reach simultaneously every individual filter plate of the interspaced filter elements.

Another advantageous design of the invention foresees the lance to have at least one opening for the purging air and the cavity to be axially movable. In this design, the individual filter elements can be cleaned very effectively one at a time.

A particularly advantageous further development of the invention foresees that the flow-dependent cleaning effectiveness be controlled by the filter device. In this case, the cleaning of the filter elements is done reliably with the least possible corresponding energy consumption.

Another advantageous design of the invention foresees an additional cleaning device to be arranged on the filter device to enhance cleaning effectiveness under high flows. In this way, the cleaning effectiveness can be optimally adapted to the flow quantity and is particularly effective with regard to energy consumption.

Preferably, as an additional cleaning device, a second lance is arranged for supplying purging air. It is particularly advantageous if the second lance is arranged largely centrically under the axis of the filter device, so the purging air can specifically reach the filter element that must be cleaned.

It is also advantageous for the cavity to have a pumping wheel or bucket wheel arranged as an additional cleaning device. This device would make the untreated liquid between the neighboring filter elements to start flowing, thereby preventing the coating layers that impede filtration from depositing on the filters.

Another advantageous design of the invention foresees the arrangement of an additional cleaning device for chemical cleaning. The periodic intensive chemical cleaning can also reliably remove smaller solid deposits that may accumulate on the filters. The chemical cleaning would benefit from a connection for a cleaning liquid installed on the outlet side. In this arrangement, the cleaning liquid flows against the normal direction of the flow back to the filters, thereby reducing the need for cleaning liquid compared to the cleaning taking place on the inflow side.

A further development of the invention is characterized by the fact that the lance is rotatably arranged in the cavity for chemical cleaning. In this case, the lance is arranged on a device for supplying a cleaning liquid. The cleaning of the filter elements is done externally from the inflow side when the container has been emptied, making possible a particularly effective cleaning.

A vacuum pump arranged on the outlet side of the filter device can generate a flow through the filter device and control operational demands accordingly.

It is particularly advantageous if two suction pipes are placed on the filter elements. This achieves a uniform outflow over the filter surface and a uniform utilization of the filter.

In a process according to the invention for cleaning the filter elements of a filter device, a cleaning of the rotating filter elements takes place during their operation though purging air. In this case, the filter elements form a cavity and are interspaced in a circular or polygonal manner and rotatably arranged within a container that contains the untreated liquid. Thus, the cleaning of the filter elements can be done continuously or discontinuously. The continuous cleaning with purging air cleans the filter plates without damaging them and largely prevents the accumulation of solids on the filters. The use of air for rinsing purposes allows cleaning to be particularly effective while using little energy.

In this case, it is particularly advantageous if the purging air flows through the filter elements from the middle towards the top. The inflow of the purging air takes place here through a lance centrically arranged in the cavity, for example. In this case, the purging air can only flow through one-half of the diameter of the filter elements, thereby enhancing even more the efficiency of the cleaning process.

An advantageous further development of the process is characterized in that the cleaning effectiveness depends on the flow through the filter device that is being controlled. With respect to energy consumption and costs, the cleaning of the filter elements can be done particularly effectively as a result of this.

Another advantageous design shape of the invention foresees that the interspaced filter elements are cleaned sequentially—in other words, one after another. The targeted inflow of purging air to an individual filter element makes a particularly intensive cleaning possible.

Another further development of the process foresees that during an operation with higher flows, a second cleaning device can be added to increase cleaning efficiency at least part of the time. The merely partial use of a second cleaning device allows the cleaning efficiency to be excellently adapted to the flows and operational demands, so that a reliable cleaning with relatively low energy consumption can be achieved with every flow.

It is likewise advantageous if an intermittent chemical cleaning of the filter elements takes place with a cleaning liquid, so that any smaller solid deposits that may have gotten stuck to the filters can be removed.

The cleaning process is enhanced if the cleaning liquid for chemical cleaning purposes is supplied under pressure. This ensures that the cleaning liquid will reach the entire surface of the filter elements.

Preferably, the cleaning liquid should flow in the opposite direction of the filtrate's flow. If the cleaning takes place with a full container, very little cleaning liquid can be used.

To increase the effectiveness of the cleaning process even more, it is advantageous for the filter elements to rotate while the chemical cleaning takes place. As a result of this, the cleaning liquid is mixed extremely well on the filter surface. Also advantageous is the cleaning with purging air during chemical cleaning. In this case, the overflow with air supports chemical cleaning from the inflow side.

Another advantageous further development of the invention foresees that, in order to be chemically cleaned, the container that contains the untreated liquid be emptied first so the cleaning liquid can flow over the lance arranged in the cavity. Here, the cleaning liquid acts directly on the side of the inflow and on the solids that have deposited on the filters.

Other advantageous designs of the invention are described by means of the following execution examples:

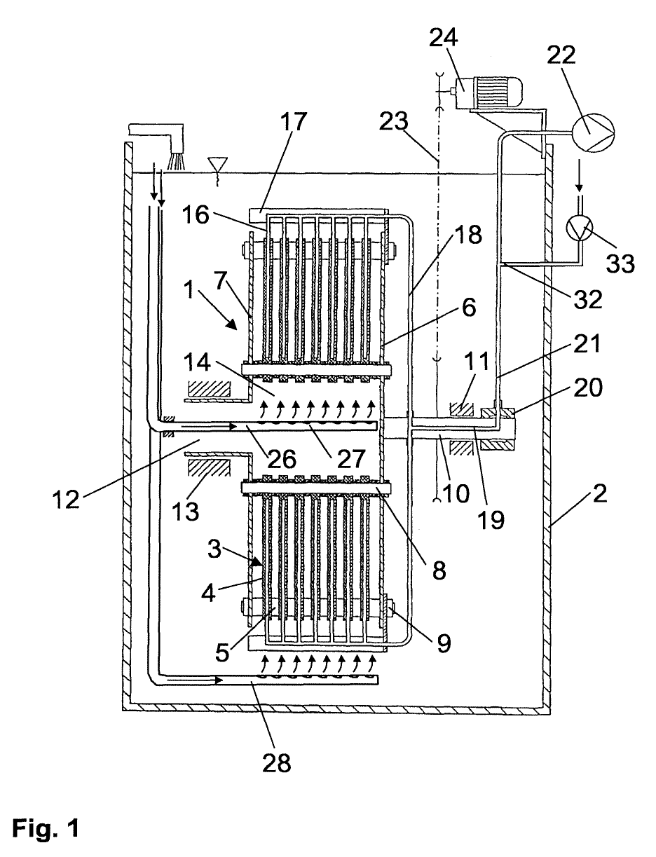

FIG. 1 shows a lateral view of the diagrammatic representation of the filter device according to the invention,

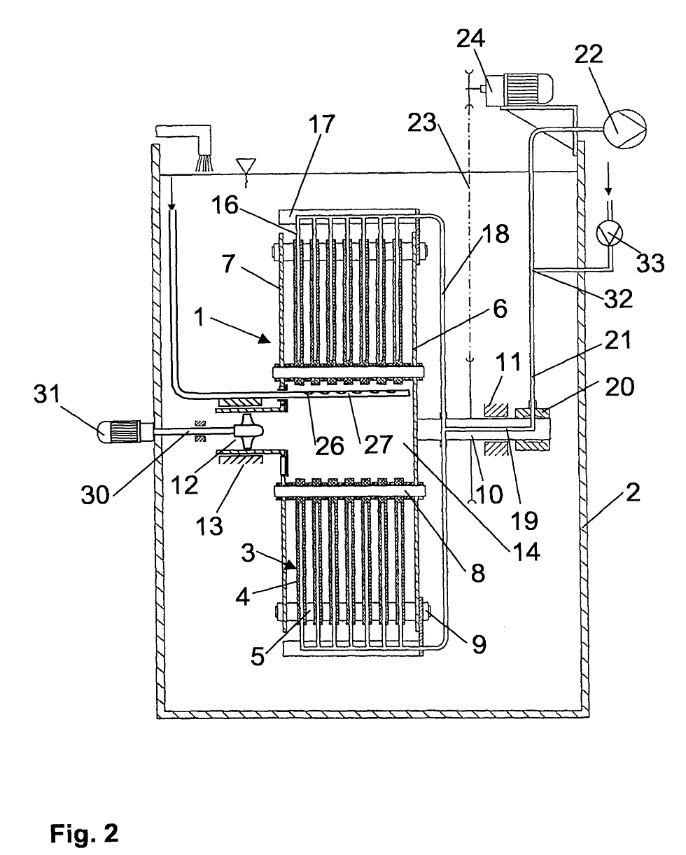

FIG. 2 shows a lateral view of the diagrammatic representation of the filter device with a bucket wheel for generating the flow,

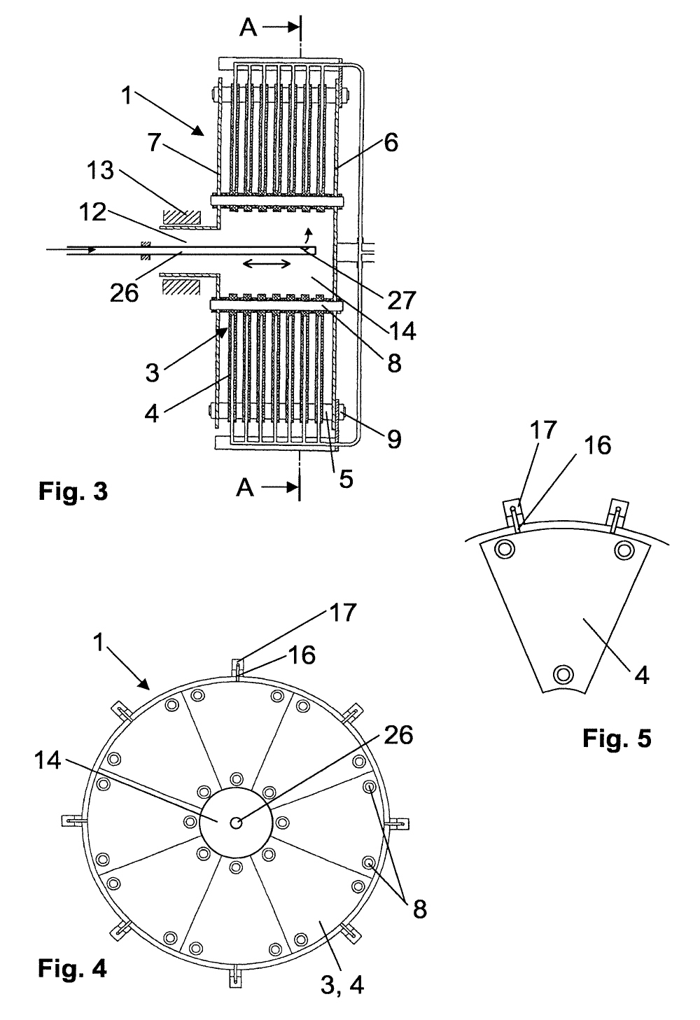

FIG. 3 shows a detailed representation of the filter device with an axially movable lance for the inflow of purging air,

FIG. 4 shows a sectional view of the filter device according to line A-A as per FIG. 3,

FIG. 5 shows an enlarged view of a filter element with two suction pipes.

FIG. 1 shows a lateral view of the filter device according to the invention. The filter device 1 is rotatably arranged in a container 2 that contains the filter liquid and consists of several filter modules 3, which are arranged in a circular manner and therefore create a cavity 14. The filter modules 3 are made up of several interspaced filter elements 4 consisting of known filter plates—not shown in the diagram—through which the filtrate flows through and that are equipped with filters on both sides. The individual filter elements 4 are adjusted with the separating disks 5 at a distance of about 4-6 mm from one another. The filter modules 3 are fastened to a supporting disk 6 and a bearing flange 7 with rods 8 and nuts 9. The supporting disk 6 is solidly connected with a primary shaft 10 and rotatably supported in bearing 11. The bearing flange 7 has a suction opening 12 and is guided in a bearing 13. The cavity 14 is connected with the container 2 that contains the filter liquid through the suction opening 12. The individual filter elements 4 are connected to the suction pipes 16, which are connected to channel rails 17 attached to the supporting disk 6 and empty into the pipelines 18 on the front. The pipelines 18 run star-shaped along the front of the supporting disk 6 according to the number of the filter modules 3 and are attached to the primary shaft 10. The pipelines 18 are connected to a sliding ring 20 arranged on the primary shaft 10 through connecting channels 19. Another pipeline 21 is connected to the sliding ring 20 that leads to a vacuum pump 22. The filter device 1 is driven by a motor 24 equipped with a chain drive 23.

During operation, while the rotating movement takes place, the filter device 1 suctions the filtrate from the container 2 with the vacuum pump 22 then it flows into the filters of the filter elements 4 and is then diverted through suction pipes 16, channel rails 17, pipelines 18, connecting channels 19, the sliding ring 20 and the pipeline 21. The liquid flowing through the filter device 1 can be controlled with the vacuum pump 22.

For cleaning the filter elements 4 in the cavity 14, a lance 26 has been arranged through which the purging air is applied on the rotating filter elements 4. The cleaning process is done wear-proof by the centrically supplied purging air, whereby the lance 26 allows the inflowing air to reach the filter elements 4. The purging air flows through every circularly arranged filter from bottom to top so that the cleaning of the neighboring filter elements 4 takes place sequentially due to the rotation. In this illustration, the lance 26 has many openings 27 for the purging air, so that the cleaning of several interspaced filter elements 4 can take place simultaneously. It is also possible for the lance 26 to have only one opening 27, as shown in FIG. 3.

The cleaning with purging air, especially under continuous thorough cleaning, largely prevents the accumulation of coating layers that interfere with filtration; compared to other known filter devices, energy consumption is still low, so that the filter device 1 can be quite effective even under low flow conditions. The degree of effectiveness improves more if the flow-dependent cleaning effectiveness is controlled by the filter device 1. In contrast, the construction expense for such a controllable cleaning device is low.

In this example, a second lance 28 has been centrically arranged under the axis of the filter device 1 for high-flow operation. This lance is turned on only part of the time according to operational needs to support the cleaning effectiveness of the lance 26. Due to the arrangement under the filter device 1 and the higher damming caused by this, the lance 28 has somewhat higher energy expenditure than the lance 26. The purposeful intermittent turning on of the second lance 26 can optimally adjust cleaning effectiveness and energy expenditure for all operating states.

According to FIG. 2, another execution possibility foresees that an additional cleaning is done with a liquid current in cases of high flow. To achieve this, in the suction opening 12 of the bearing flange 7 a bucket wheel 30 driven by a separate motor 31 has been arranged. In this execution, the cavity 14 is closed on one side by the supporting disk 6. The bucket wheel 30 generates a defined flow between the interspaced filter elements 4 in the filter liquid, so that the solids pulled by the filter suction do not remain attached to the filters and are continuously entrained by the liquid streaming by. In this example, the flow is generated by an axial bucket wheel 30, but other flow-generating elements are also possible. As shown here, the bucket wheel 30 is preferably submerged in container 2. However, especially in the case of container installations, a flow-generating element can also be arranged outside of the container 2 and be connected with the suction opening 12 and the container 2 through pipes.

In order to remove solid deposits from the filter surfaces, a chemical cleaning of the filter elements 4 is done regularly. To achieve this, a connection 32 for a filter liquid has been arranged before the vacuum pump 22 on the outlet side. The cleaning liquid is pumped towards the filter elements 4 against the direction in which the filtrate flows with a pump 33. The chemical cleaning takes place when the container 2 is full to protect the delicate filter surfaces or membranes from excessive pressure load. The cleaning liquid enters from the outlet side through the pores of the filter elements 4 and dissolves the solid deposits adhering to them. In this case, the rotating filter elements 4 contribute significantly to mix the cleaning liquid. Purging air is introduced via the lance 26 from the inflow side, which enhances the cleaning effectiveness of the cleaning liquid even more. However, if a filter device 1 according to the invention is used in a filtration chamber, it also possible to empty the container 2 for the chemical cleaning, thereby making possible a particularly effective cleaning of the filter elements 4 from the inflow side. For example, the cleaning liquid can be supplied through the lance 26. For this purpose, the lance 26 is rotatably arranged in the cavity 14. To supply the cleaning liquid, the openings 27 of the lance 26 are oriented downwards.

FIG. 3 shows a detailed representation of the filter device 1 with an axially movable lance 26 for supplying purging air. In this case, the lance 26 has only one opening 27 for the purging air. The interspaced filter elements 4 are individually cleaned one after another, whereby the lance 26 is always axially displaced by the separating distance between the filter elements 4. This allows a very thorough cleaning of the individual filter elements 4.

The design of the filter device from individual, circularly arranged filter elements 4 or filter modules 3 can be seen in the sectional view of FIG. 4. In the interior of the cavity 14 created by the filter elements 4 one finds the lance 26 as cleaning device for supplying purging air. The filtrate enters through the filter elements 4 and is diverted via the suction pipes 16 and the channel rails 17. An especially uniform outlet through the filter surface can be achieved if two suction pipes 16 are arranged in a filter element 4, as shown in FIG. 5.

This invention is not restricted to the described execution examples. The invention also includes more modifications that are part of the patent claims or combinations.

1. Filter device for purifying polluted liquids, particularly waste water, consisting of several interspaced filter elements (4) that create filter modules (3) and are rotatably arranged in a circular or polygonal manner in a container (2) that contains untreated liquid, in such a way that the filter modules (3) arranged in a circular or polygonal manner form a cavity 14) that is connected to the container (2) through a suction opening (12), characterized in that a cleaning device for cleaning the filter elements (4) with purging air is arranged on and/or in the cavity (14).

2-24. (canceled)
